(19) United States
(12) Patent Application Publication
(10) Pub. No.: US 2025/0111776 A1
(43) Pub. Date: Apr. 3, 2025

(54) DEVICE, SYSTEM, AND METHOD FOR CONTROLLING VEHICLE-RELATED FUNCTIONALITY

(71) Applicant: MOTOROLA SOLUTIONS, INC., Chicago, IL (US)

(72) Inventors: Stephanie E. JONES, Marietta, GA (US); Daniel R. BESTOR, Schaumburg, IL (US); Peter L. VENETIANER, McLean, VA (US)

(21) Appl. No.: 18/374,783

(22) Filed: Sep. 29, 2023

(51) Int. Cl. G08G 1/0965; B60K 35/00; H04W 4/46

(52) U.S. Cl. CPC G08G 1/0965; B60K 35/00; B60K 35/22; B60K 35/29; B60K 2360/1868; H04W 4/46

(57) ABSTRACT

A device, system, and method for controlling vehicle-related functionality is provided. A system comprises: a vehicle comprising: a vehicle display; a mobile device comprising: a mobile display, the vehicle and the mobile device communicatively coupled to each other; a transceiver; and a controller. The controller is configured to: determine, via the transceiver, whether the vehicle is a first vehicle or a subsequent vehicle to arrive at an incident scene. When the vehicle is the first vehicle to arrive at the incident scene, the controller selectively enables: a first application for presentation at the vehicle display; and a second application for presentation at the mobile display. When the vehicle is the subsequent vehicle to arrive at the incident scene, the controller selectively enables: a third application, different from the first application, for presentation at the vehicle display; and a fourth application for presentation at the mobile display.

### BACKGROUND OF THE INVENTION

In first responder environments, functionality provided at vehicles may be important for first responders to manage an incident. Such functionality may be provided at a respective mobile device display and/or a respective vehicle display of the vehicles, however such displays tend to mirror each other, which may be a waste of processing resources, bandwidth resources, a waste of display space and/or an opportunity to add additional useful functionality.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 depicts a system for controlling vehicle-related functionality, in accordance with some examples.

FIG. 2 is a device diagram showing a device structure of a computing device for controlling vehicle-related functionality, in accordance with some examples.

FIG. 3 is a flowchart of a method for controlling vehicle-related functionality, in accordance with some examples.

FIG. 4 depicts the system of FIG. 1 implementing aspects of a method for controlling vehicle-related functionality, in accordance with some examples.

FIG. 5 depicts the system of FIG. 1 implementing further aspects of a method for controlling vehicle-related functionality, in accordance with some examples.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

In first responder environments, functionality provided at vehicles may be important for first responders to manage an incident. Such functionality may be provided at a respective mobile device display and/or a respective vehicle display of the vehicles, however such displays tend to mirror each other, which may be a waste of processing resources, bandwidth resources, a waste of display space and/or an opportunity to add additional useful functionality. For example, in applications such as Apple CarPlay™ or Android Auto™, a mobile device may control a vehicle display, but such control is limited. Thus, there exists a need for an improved technical method, device, and system for controlling vehicle-related functionality.

Hence, provided herein is a device, system, and method for controlling vehicle-related functionality. The system comprises a vehicle (e.g., a police car, a fire truck, an ambulance, a security guard vehicle, amongst other possibilities, and the like), which may be a first vehicle, or a subsequent vehicle to arrive at an incident scene (e.g., a police-related incident, traffic stop, a 911-related incident, a fire-related incident, a medical-related incident, a security-related incident, amongst other possibilities). The vehicle generally comprises a vehicle display, and the system further comprises a mobile device that includes a mobile display, which may be located in the vehicle, and/or which may be carried outside the vehicle. Regardless, the vehicle and the mobile device are communicatively coupled to each other.

The system further comprises a transceiver and a controller (e.g., such as a processor, and the like). The transceiver and controller may be components of the vehicle and/or the mobile device. The controller is generally configured to determine, via the transceiver, whether the vehicle is a first vehicle or a subsequent vehicle to arrive at the incident scene. For example, to make such a determination, the controller may communicate (e.g., via the transceiver) with other vehicles at an incident scene and/or the controller may communicate (e.g., via the transceiver) with a cloud server configured to track vehicles at the incident scene.

In general, different vehicles may arrive at the incident scene at different time, and the vehicle may be a first vehicle or a subsequent vehicle to arrive at the incident scene. Depending on whether the vehicle is the first vehicle, or the subsequent vehicle, to arrive at the incident scene, the controller may place the vehicle display and the mobile display into different modes. For example, in response to determining that the vehicle is the first vehicle to arrive at the incident scene, the controller selectively enables a first vehicle support mode at the vehicle display and the mobile display. However, in response to determining that the vehicle is a subsequent vehicle to arrive at the incident scene, the controller selectively enables a subsequent vehicle support mode at the vehicle display and the mobile display.

In particular, in some examples of the first vehicle support mode, when the vehicle is the first vehicle to arrive at the incident scene, the controller selectively enables: a first application for presentation at the vehicle display; and a second application for presentation at the mobile display. Such applications may be the same or different, but may generally provide different information.

However, in some examples of the subsequent vehicle support mode when the vehicle is the subsequent vehicle to arrive at the incident scene, the controller selectively enables: a third application, different from the first application, for presentation at the vehicle display; and a fourth application for presentation at the mobile display. Hence, the third application enabled at the vehicle display of the subsequent vehicle is different from the first application enabled at the vehicle display of the first vehicle.

Furthermore, in some examples, the third application enabled at the vehicle display of the subsequent vehicle may be enabled as a function of the first application enabled at the vehicle display of the first vehicle. For example, the application enabled at the vehicle display of the subsequent vehicle may be enabled to complement the first application enabled at the vehicle display of the first vehicle.

The fourth application enabled at the mobile display of the subsequent vehicle may be the same or different as the third application enabled at the vehicle display of the subsequent vehicle, but may generally provide different information. The fourth application enabled at the vehicle display of the subsequent vehicle may be the same or different from the second application enabled at the vehicle display of the first vehicle, but may generally provide different information. However, when the fourth application is the same as the third application, and the second application is the same as the first application, the fourth application is different from the second application (e.g., as the third application is different from the first application).

Put another way, depending on whether the vehicle is a first vehicle, or a subsequent vehicle, to arrive at the incident scene, the controller may place the vehicle display and the mobile display into a first vehicle support mode or a subsequent vehicle support mode, and which may be complementary to each other, for example to more efficiently use processing resources of the vehicle and/or the mobile devices in assisting first responders at an incident scene.

In the first vehicle support mode, applications provided at the vehicle display and the mobile display may depend on data received from subsequent vehicles that arrived at the incident scene, and in the subsequent vehicle support mode, applications provided at the vehicle display and the mobile display may depend on data received from the first vehicle that arrived at the incident scene.

Data provided at the vehicle display and the mobile display of a first vehicle may be different from one another, and different from data provided at vehicle displays and mobile displays of subsequent vehicles. Similarly, data provided at the vehicle display and the mobile display of a subsequent vehicle may be different from one another, and different from data provided at vehicle displays and mobile displays of a first vehicle. In this manner, data may not be duplicated (e.g., and/or not completely duplicated) between the vehicle displays and the mobile displays of a first vehicle and subsequent vehicles to arrive at an incident scene, and furthermore, such data may be controlled to coordinate an improved response by first responders to an incident at the incident scene.

Put another way, selective enablement of applications at the vehicles, depending on a determination of whether a vehicle is a first vehicle, or a subsequent vehicle, to arrive at an incident scene, may be to ensure that functionality provided in association with a first vehicle to arrive at the incident scene is different from functionality provided in association with a subsequent vehicle to arrive at the incident scene, for example to use processing resources and/or bandwidth resources at the vehicles at the incident scene more efficiently, and/or so as not to duplicate processing at the vehicles at the incident scene, and/or to assist the vehicles, and associated mobile devices, to cooperate in a manner that may enable an incident at the incident scene to be more quickly resolved.

However, it is further understood that, in the first vehicle support mode or the second vehicle support mode, one or more of the same applications may be enabled at the vehicle display and the mobile display, but in different modes. For example, in the first vehicle support mode, or the subsequent vehicle support mode, a same application may be selectively enabled at the vehicle display and the mobile display, but different information may be provided at the vehicle display and the mobile display, for example to use processing resources and/or bandwidth resources at the vehicles at the incident scene more efficiently, and/or so as not to duplicate processing at the vehicles at the incident scene, and/or to assist the vehicles, and associated mobile devices, to cooperate in a manner that may enable an incident at the incident scene to be more quickly resolved.

Such selective enablement of applications, and/or modes, may be to ensure that functionality provided in association with a first vehicle to arrive at the incident scene is different from functionality provided in association with a subsequent vehicle to arrive at the incident scene, for example to use processing resources and/or bandwidth resources at the vehicles at the incident scene more effectively and/or so as not to duplicate processing at the vehicles at the incident scene, and/or to add additional useful functionality to assist the vehicles, and associated mobile devices, and their occupant owner operators, in cooperating in a manner that may enable an incident at the incident scene to be more quickly managed and/or resolved. In particular, from a point of view of the occupant owner operators such selective enablement of applications, and/or modes, may assist in resolving an incident at the incident scene faster and/or better than if such selective enablement of applications and/or modes did not occur. Indeed, such selective enablement of applications, and/or modes, may cause the vehicle display and/or the mobile display to provide information and/or functionality that is most relevant for respective occupant owner operators, which may be achieved by providing different information and/or different functionality to different occupant owner operators. It is further understood however, that such selective enablement of applications, and/or modes may generally optimize use processing resources and/or bandwidth, for example, by using a controller of one of a mobile device or a vehicle computing device for selective enablement of applications, and/or modes and centrally controlling such selective enablement of applications, and/or modes.

An aspect of the present specification provides a system comprising: a vehicle comprising: a vehicle display; a mobile device comprising: a mobile display, the vehicle and the mobile device communicatively coupled to each other; a transceiver; and at least one controller configured to: determine, via the transceiver, whether the vehicle is a first vehicle or a subsequent vehicle to arrive at an incident scene; when the vehicle is the first vehicle to arrive at the incident scene: selectively enable: a first application for presentation at the vehicle display; and a second application for presentation at the mobile display; and when the vehicle is the subsequent vehicle to arrive at the incident scene: selectively enable: a third application, different from the first application, for presentation at the vehicle display; and a fourth application for presentation at the mobile display.

Another aspect of the present specification provides a method comprising: determining, at a computing device, via a transceiver, whether a vehicle is a first vehicle or a subsequent vehicle to arrive at an incident scene; when the vehicle is the first vehicle to arrive at the incident scene: selectively enabling, via the computing device: a first application for presentation at a vehicle display of the vehicle; and a second application for presentation at a mobile display of a mobile device, the vehicle and the mobile device communicatively coupled to each other; and when the vehicle is the subsequent vehicle to arrive at the incident scene: selectively enabling, via the computing device: a third application, different from the first application, for presentation at the vehicle display; and a fourth application for presentation at the mobile display.

Each of the above-mentioned aspects will be discussed in more detail below, starting with an example system and device architectures of the system, in which the embodiments may be practiced, followed by an illustration of processing blocks for achieving an improved technical method, device, and system for controlling vehicle-related functionality.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and, likewise, various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus that may be on or off-premises, or may be accessed via the cloud in any of a software as a service (Saas), platform as a service (PaaS), or infrastructure as a service (IaaS) architecture so as to cause a series of operational blocks to be performed on the computer or other programmable apparatus to produce a computer implemented process such that the instructions, which execute on the computer or other programmable apparatus, provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the drawings.

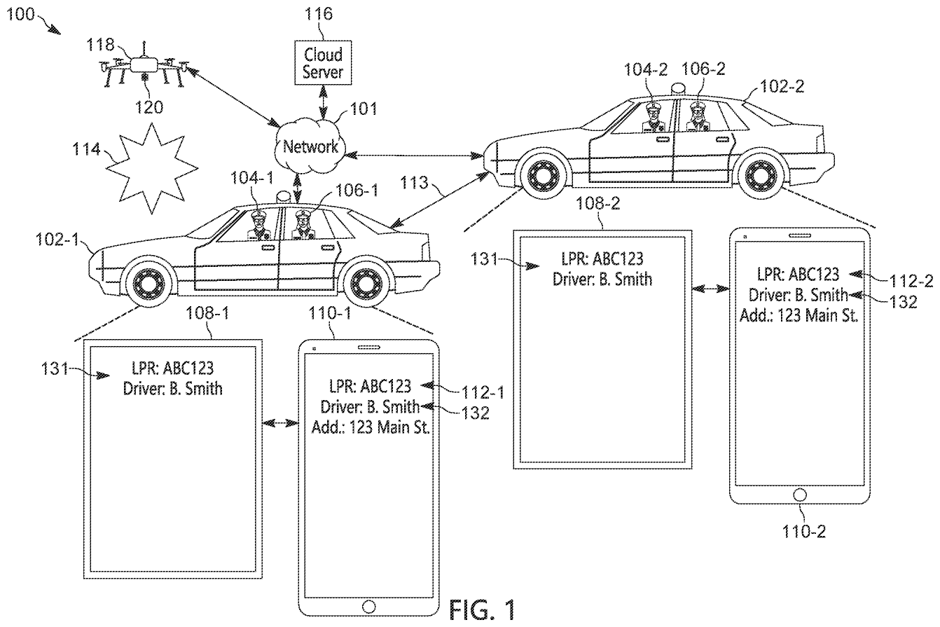

Attention is directed to FIG. 1, which depicts an example system 100 for controlling vehicle-related functionality. The various components of the system 100 are in communication via any suitable combination of wired and/or wireless communication links, and communication links between components of the system 100 are depicted in FIG. 1, and throughout the present specification, as double-ended arrows between respective components; the communication links may include any suitable combination of wireless and/or wired links and/or wireless and/or wired communication networks 101, or the like.

The system 100 comprises two vehicles 102-1, 102-2 interchangeably referred to hereafter, collectively, as the vehicles 102 and, generically, as a vehicle 102. This convention will be used throughout the present application. For example, as depicted, a respective vehicle 102 is occupied by a respective first occupants 104-1, 104-2 (e.g., first occupants 104 and/or a first occupant 104) and a respective second occupants 106-1, 106-2 (e.g., second occupants 106 and/or a second occupant 106). For example, the first occupants 104 may be drivers and the second occupants 106 may be passengers of the respective vehicles 102.

As depicted, the vehicles 102 may comprise police vehicles, and the occupants 104, 106 may comprise police officers. However, the vehicles 102 may comprise any suitable vehicle, such as a first responder vehicle, and the like (e.g., police cars, fire trucks, ambulances, security guard vehicles, amongst other possibilities). While not depicted, a vehicle 102 may comprise any suitable combination of hardware that may depend on a type of a vehicle 102. For example, when a vehicle 102 is a police vehicle, the vehicle 102 may comprise any suitable combination of a license plate reader (LPR), cameras (e.g., dashboard cameras), radios, and the like.

Similarly, the occupants 104, 106 may comprise any suitable occupants, such as any suitable first responders, and the like (e.g., police officers, fire fighters, emergency medical technicians, security guards, amongst other possibilities). While a pair of occupants 104, 106 is depicted at both vehicles 102, a vehicle 102 may include as few as one first occupant 104, such as a driver and no passenger, and as many as three to five, or more occupants.

As indicated via respective broken lines extending from respective vehicles 102, to show details of a dashboard of a respective vehicle 102, a vehicle 102 may comprise a respective vehicle display 108-1, 108-2 (e.g., vehicle displays 108 and/or a vehicle display 108), which may also be referred to as a first vehicle display 108-1 and a second vehicle display 108-2.

Furthermore, the system 100 generally comprises mobile devices 110-1, 110-2 (e.g., mobile device 110 and/or a mobile device 110), and the mobile devices 110-1, 110-2 comprise respective mobile displays 112-1, 112-2 (e.g., mobile displays 112 and/or a mobile display 112). The mobile devices 110-1, 110-2 may also be referred to as a first mobile device 110-1 and a second mobile device 110-2, and the mobile displays 112-1, 112-2 may also be referred to as a first mobile display 112-2 and a second mobile display 112-2.

In general, a vehicle display 108 comprises a display screen of a vehicle 102, and a mobile display 112 comprises a mobile display screen of a mobile device 110, and such display screens may be any suitable type of display screens (e.g., liquid crystal displays (LCDs), organic light emitting displays (OLEDs), and the like, amongst other possibilities). One or more of a vehicle display 108 and a mobile display 112 may comprise a touchscreen with an integrated input mechanism (e.g., a touch sensitive surface, and the like, and/or one or more of a vehicle display 108 and a mobile display 112 may comprise a non-touch display with a separate input mechanism (e.g., a mouse, a touchpad, a keyboard, and the like).

In general, a vehicle 102 and a respective mobile device 110 are communicatively coupled to each other, for example as indicated by a double-ended arrow between the mobile devices 110 and a respective vehicle display 108 representing a communication link therebetween. While such double-ended arrows are depicted as between the mobile devices 110 and a respective vehicle display 108 it is understood that communication between a mobile device 110 and a vehicle 102 may be between a mobile device 110 and a vehicle computing device that manages a respective vehicle display 108.

In particular, the first vehicle 102-1 comprises the first vehicle display 108-1, and the first vehicle 102-1 and the first mobile device 110-1 are communicatively coupled to each other. Similarly, the second vehicle 102-2 comprises the second vehicle display 108-2, and the second vehicle 102-2 and the second mobile device 110-2 are communicatively coupled to each other.

Such communication may be via a wired communications link (e.g., a cable between a mobile device 110 and a vehicle 102, such as between respective universal serial bus (USB) ports at a mobile device 110 and a vehicle 102, or any other suitable wired link), or such communication may be via a wireless link (e.g., a Bluetooth™ wireless link and/or a near field communication (NFC) link, and the like, between a mobile device 110 and a vehicle 102, or any other suitable wireless link). Put another way, a vehicle 102 and a mobile device 110 may be associated by virtue of a vehicle 102 and a mobile device 110 being communicatively coupled to each other, and/or a vehicle display 108 and a mobile device 110 may be associated, for example by virtue of a vehicle 102, of which the vehicle display 108 is a component, and a mobile device 110 being communicatively coupled to each other.

Hence, a mobile device 110 may comprise a mobile device located in and/or at the vehicle 102, though a mobile device 110 may be external to a vehicle 102 and remain communicatively coupled to the vehicle 102. A mobile device 110 may comprise any suitable mobile device including, but not limited to, a mobile communication device, a cell phone, a radio, a laptop, and the like.

In particular, in a “normal” mode for a vehicle display 108 and a respective mobile display 112, a vehicle 102 and an associated mobile device 110 may be implementing respective applications (e.g., a vehicle display application and a mobile display application), which enable a respective mobile display 112 and a respective vehicle display 108, to provide similar information, and/or correlated information, provided at one or the other of the respective mobile display 112 and the respective vehicle display 108. Such applications may include, but are not limited to, instances of Apple CarPlay™ being implemented at a vehicle 102 and an associated mobile device 110, instances of Android Auto™ being implemented at a vehicle 102 and an associated mobile device 110, and the like, amongst other possibilities. Indeed, some examples provided herein may represent modifications and/or additions to such applications.

Furthermore, in a “normal” mode, correlated information being provided at the displays 108, 112 may be reformatted for different respective form factors of the displays 108, 112. For example, data, content, interfaces, and the like, at one display 108, 112 may be substantially, partially, or not at all correlated to data, content, interfaces at the other display 108, 112, including in some instances, mirroring one another, such that operations performed on one display 108, 112, at least in some embodiments, affects data, content, interfaces provided at the other display 108, 112.

The term “normal mode”, as used herein, further include any suitable mode that occurs at a vehicle display 108 and/or a mobile device display 112 before a first vehicle support mode or subsequent vehicle support mode is implemented, The “normal” mode may include a mode in which a vehicle display 108 and a mobile device display 112 mirror each other (e.g., a “mirror mode”) or some other configuration, such as a blacked out screen mode, a mapping/driving directions mode, and/or an incident or task list mode, among other possibilities or combinations of the foregoing.

In some examples, similar information being provided at the displays 108, 112 may mirror each other and the “normal” mode may colloquially be referred to as a “mirror” mode. However, the term “mirror” as used herein with respect to a mobile display 112 and an associated vehicle display 108 may include providing same, or similar, or correlated information, at both of the displays 108, 112, formatted according to a respective form factor of the displays 108, 112; such information need not be identical, however.

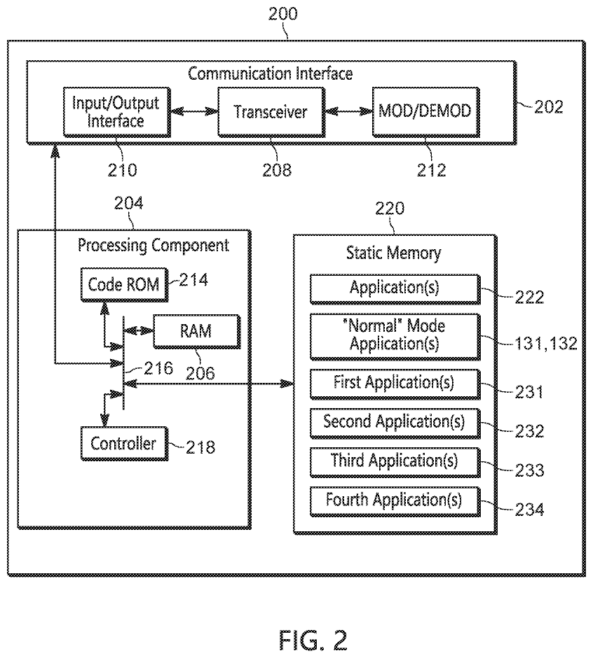

As will be presently explained with respect to FIG. 2, the system 100 further comprises, for a pair of a vehicle 102 and an associated mobile device 110, a transceiver and at least one controller (e.g., a processor, and the like, and hereafter the controller) that are communicatively coupled to each other. The transceiver and the controller may be components of the vehicle 102 and/or components of the associated mobile device 110. Indeed, in some examples, the transceiver may be a component of one of a vehicle 102 and an associated mobile device 110, and the controller may be a component of the other of the vehicle 102 and the associated mobile device 110. Hence, for example, via a respective communication link between a vehicle 102 and an associated mobile device 110, computing resources and communication and/or radio resources may be shared between a vehicle 102 and an associated mobile device 110.

In particular, such a controller may include, but is not limited to, one or more an In-Car Processor (ICP) of a vehicle 102 and a mobile processor of an associated mobile device 110, amongst other possibilities, described below with respect to FIG. 2.

Furthermore, in the context of first responders, such a transceiver may include, but is not limited to, one or more of a vehicle-to-vehicle (V2V) transceiver (e.g., used to communicate between vehicles 102 when they are within a given distance, such as 100 meters, 250 meters, 500 meters, and the like, amongst other possibilities), a digital mobile radio (DMR) transceiver, a Project 25 (P25) transceiver, a terrestrial trunked radio (TETRA) transceiver, and a cellular transmitter, amongst other possibilities, described below with respect to FIG. 2.

Hence, vehicles 102, as described herein, may be directly communicatively coupled to each other, may be communicatively coupled via the network 101, and/or may be communicatively coupled via one or more networks external to the network 101.

For example, when the vehicles 102 are communicatively coupled via the network 101, communication links between the network 101 and the vehicles 102, as depicted in FIG. 1, are understood to represent communication links between respective transceivers of the vehicles 102 (e.g., which may include, but is not limited to, transceivers of the mobile devices 110), and the network 101.

Alternatively, and/or in addition, vehicles 102, as described herein, may be communicatively coupled to each other via a wireless and/or radio communication link (e.g., that may exclude the network 101) therebetween. For example, as depicted in FIG. 1, the vehicles 102 may be communicatively coupled via a direct V2V wireless communication link 113 (e.g., via respective V2V transceivers of the vehicles 102, though one or more of such V2V transceivers may alternatively be incorporated into one or more of the mobile devices 110).

A particular scenario will next be described, which will be used to better explain examples provided herein.

As depicted, one or more of the vehicles 102 may have been dispatched to an incident scene 114 that, while for simplicity is depicted generically as a star, is understood to include any suitable combination of vehicles, people, buildings, roads, or other infrastructure, amongst other possibilities, involved in an incident at the incident scene 114.

Continuing with the example, a vehicle 102, such as the first vehicle 102-1 may have arrived at the incident scene 114 without being dispatched, and reported the incident scene 114, for example to a cloud server 116 via the associated mobile device 110-1. The cloud server 116 may comprise, or be a component of, a public-safety answering point (PSAP), dispatch center, and the like, and the cloud server 116 may have been used (e.g., by a dispatcher, not depicted), to dispatch other vehicles 102, such as the second vehicle 102-2, to the incident scene 114. Hence, in the particular example, the first vehicle 102-1 may comprise a first vehicle 102-1 to arrive at the incident scene 114, and the second vehicle 102-2 may comprise a subsequent vehicle 102-2 to arrive at the incident scene 114. While only one subsequent vehicle 102-2 is depicted, it is understood that more than one subsequent vehicles 102 may have arrived at the incident scene 114.

Alternatively, all the vehicles 102 may be dispatched to the incident scene 114, for example when a call is received (e.g., from a member of the public, or a first responder, amongst other possibilities) at a PSAP and/or a dispatch center, and the like.

However, in other examples, no dispatch may have occurred and the vehicles 102 may be on a routine patrol and come across the incident scene 114.

The cloud server 116 may furthermore generate an incident report for the incident of the incident scene 114. For example, a location of the incident scene 114 may be determined for example in the form of an address, GPS coordinates, and the like, when a first vehicle 102 that arrives at the incident scene 114 reports an incident of the incident scene 114 (and/or the incident of the incident scene 114 is reported via call), including the location, to the cloud server 116 and/or the other vehicles 102. Such a location may be stored at an incident report, which may be generated by the cloud server 116, and which may also include a type of the incident scene 114.

As depicted, a drone 118, and the like, may have been dispatched (e.g., via the cloud server 116) and/or launched (e.g., by one of the vehicles 102) to hover over the incident scene 114, and the like, and stream video of the incident scene 114 to the cloud server 116 (and/or one or more of the vehicles 102), via the network 101, and/or to one or more of the vehicles 102 directly (e.g., via a V2V communication link), the video acquired via a camera 120 carried by the drone 118 (e.g., as depicted, the drone 118 may comprise a camera 120).

The incident scene 114 may be for any suitable incident, which may be managed by any suitable first responders, and which may include, but is not limited to, a police-related incident, a traffic stop, a 911-related incident, a fire-related incident, a medical-related incident, a security-related incident, and the like, amongst other possibilities.

In general, for a vehicle 102 and an associated mobile device 110, a respective controller is generally configured to determine, via a respective transceiver, whether the vehicle 102 is a first vehicle 102 to arrive at the incident scene 114, or a subsequent vehicle 102 to arrive at the incident scene 114. Such a determination may occur via communication with the cloud server 116, which may track the vehicles 102 at the incident scene 114, and/or such a determination may occur via communication with other vehicles 102 at the incident scene 114 (e.g., which may exchange information indicative of when they respectively arrived at the incident scene 114, and the like).

As depicted in FIG. 1, prior to determination of a vehicle 102 being a first vehicle or subsequent vehicle to arrive at the incident scene 114, respective applications 131, 132 (e.g., a vehicle display application 131 and a mobile display application 132) have been selectively implemented at the vehicle displays 108 and the mobile displays 112. For example in FIG. 1, using a traffic stop as an example incident of the incident scene 114, the applications 131, 132 may comprise complementary LPR applications. For example, at the vehicle displays 108, an LPR application of the application 131 at a vehicle display 108 includes LPR data of a license plate number (e.g., “ABC123”) and a name of a driver (e.g., “B. Smith”) associated with the license plate number. Similarly, at the mobile displays 112, an LPR application of the application 132 includes the same LPR data provided at the vehicle displays 108, but expanded to include an address (e.g., “123 Main St.”) of the driver associated with the license plate number. Alternatively, or in addition, the vehicle displays 108 and respective mobile displays 110 may mirror each other (e.g., in a “mirror mode”), and the like.

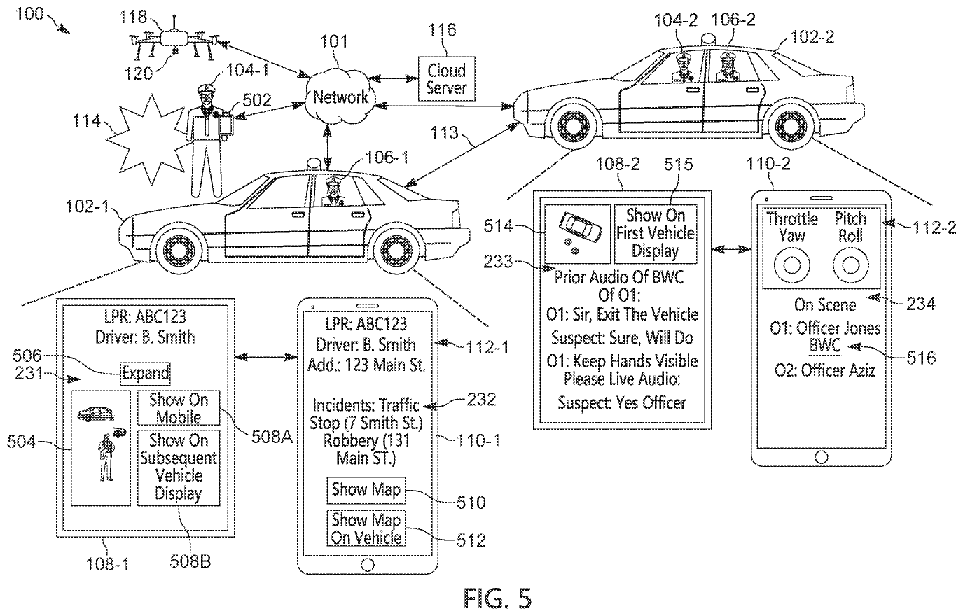

However, in some examples, as will be described with respect to FIG. 5, when a vehicle 102 is a first vehicle to arrive at the incident scene 114, an associated controller may selectively enable: a first application for presentation at a respective vehicle display 108; and a second application for presentation at a respective mobile display 112. However, when the vehicle 102 is a subsequent vehicle to arrive at the incident scene 114, the associated controller may: selectively enable: a third application, different from the first application, for presentation at the vehicle display 108; and a fourth application for presentation at the mobile display 112.

Alternatively, or in addition, when a vehicle 102 is a first vehicle to arrive at the incident scene 114, an associated controller may: selectively enable a first vehicle support mode at one or more of a respective vehicle display 108 and a respective mobile display 112; and a second application for presentation at a respective mobile display 112. However, when the vehicle 102 is a subsequent vehicle to arrive at the incident scene 114, the associated controller may: selectively enable a subsequent vehicle support mode at one or more of a respective vehicle display 108 and a respective mobile display 112.

Put another way, depending on whether a vehicle 102 is a first vehicle, or a subsequent vehicle, to arrive at the incident scene 114, a controller may place an associated vehicle display 108 and mobile display 112 into a first vehicle support mode or a subsequent vehicle support mode.

Such selective enablement of applications, and/or modes, may be to ensure that functionality provided in association with a first vehicle 102 to arrive at the incident scene 114 is different from functionality provided in association with a subsequent vehicle 102 to arrive at the incident scene 114, for example to use processing resources and/or bandwidth resources at the vehicles 102 at the incident scene 114 more effectively and/or so as not to duplicate processing at the vehicles 102 at the incident scene 114, and/or to add additional useful functionality to assist the vehicles 102, and associated mobile devices 110 and their occupant owner operators (e.g., the occupants 104, 106), in cooperating in a manner that may enable an incident at the incident scene 114 to be more quickly managed and/or resolved. In particular, from a point of view of the occupant owner operators (e.g., the occupants 104, 106) such selective enablement of applications, and/or modes, may assist in resolving an incident at the incident scene 114 faster and/or better than if such selective enablement of applications did not occur. Indeed, such selective enablement of applications, and/or modes, may cause the displays 108, 112 to provide information and/or functionality that is most relevant for respective occupant owner operators, which may be achieved by providing different information and/or different functionality different things to different occupant owner operators. It is further understood however, that such selective enablement of applications, and/or modes may generally optimize use processing resources and/or bandwidth in the system 100, for example, by using a controller of one of a mobile device 110 or a vehicle computing device for selective enablement of applications, and/or modes and centrally controlling such selective enablement of applications, and/or modes.

Attention is next directed to FIG. 2, which depicts a schematic block diagram of an example of a computing device 200, which may comprise a computing device of a vehicle 102 and/or an associated mobile device 110. While the computing device 200 is depicted in FIG. 2 as a single component, functionality of the computing device 200 may be distributed among a plurality of components and the like including, but not limited to, any suitable combination of a vehicle 102 and an associated mobile device 110, and the like.

As depicted, the computing device 200 comprises: a communication interface 202, a processing unit 204, a Random-Access Memory (RAM) 206, one or more wireless transceivers 208, one or more wired and/or wireless input/output (I/O) interfaces 210, a combined modulator/demodulator 212, a code Read Only Memory (ROM) 214, a common data and address bus 216, at least one controller 218 (e.g., hereafter the controller 218), and a static memory 220 storing at least one application 222. Hereafter, the at least one application 222 will be interchangeably referred to as the application 222. Furthermore, while the memories 206, 214 are depicted as having a particular structure and/or configuration, (e.g., separate RAM 206 and ROM 214), memory of the computing device 200 may have any suitable structure and/or configuration.

While not depicted, the computing device 200 may include, and/or be communicatively coupled to, one or more of an input component and a display screen (e.g., one or more of displays 108, 112) and the like.

As shown in FIG. 2, the computing device 200 includes the communication interface 202 communicatively coupled to the common data and address bus 216 of the processing unit 204.

The processing unit 204 may include the code Read Only Memory (ROM) 214 coupled to the common data and address bus 216 for storing data for initializing system components. The processing unit 204 may further include the controller 218 coupled, by the common data and address bus 216, to the Random-Access Memory 206 and the static memory 220.

The communication interface 202 may include one or more wired and/or wireless input/output (I/O) interfaces 210 that are configurable to communicate with other components of the system 100. For example, the communication interface 202 may include one or more transceivers 208 for wirelessly communicating with other suitable components of the system 100. Hence, the one or more transceivers 208 may be adapted for communication with one or more communication links and/or communication networks used to communicate with the other components of the system 100. For example, the one or more transceivers 208 may be adapted for communication with one or more of the Internet, a digital mobile radio (DMR) network, a Project 25 (P25) network, a terrestrial trunked radio (TETRA) network, a Bluetooth network, a Wi-Fi network, for example operating in accordance with an IEEE 802.11 standards (e.g., 802.11a, 802.11b, 802.11g), a 3GPP (3rd Generation Partnership Project) 4G LTE (Long-Term Evolution) network, a 3GPP 5G network (e.g., a network architecture compliant with, for example, the 3GPP TS 23 specification series and/or a new radio (NR) air interface compliant with the 3GPP TS 38 specification series) standard), a Worldwide Interoperability for Microwave Access (WiMAX) network, for example operating in accordance with an IEEE 802.16 standard, and/or other types of GSM (Global System for Mobile communications) and/or another similar type of wireless networks. Hence, the one or more transceivers 208 may include, but are not limited to, a cell phone transceiver, a DMR transceiver, P25 transceiver, a TETRA transceiver, a 3GPP transceiver, a 4G LTE transceiver, a GSM transceiver, a 5G transceiver, a Bluetooth transceiver, a Wi-Fi transceiver, a WiMAX transceiver, and/or another similar type of wireless transceiver configurable to communicate via a wireless radio network.

It is understood that DMR transceivers, P25 transceivers, and TETRA transceivers may be particular to public entity first responders, and hence, in some examples, the system 100 may be operated by a first responder public entity (e.g., such as a police department, a fire department, an emergency medical services department, and the like). In other examples, however, the system 100 may be operated by an enterprise entity, including, but not limited to, business, industrial or utility entities, which, for example, may deploy private first responders to an incident scene (e.g., such as security guards and the like).

The communication interface 202 may further include one or more wireline transceivers, such as an Ethernet transceiver, a USB (Universal Serial Bus) transceiver, or similar transceiver configurable to communicate via a twisted pair wire, a coaxial cable, a fiber-optic link, or a similar physical connection to a wireline network.

The transceiver 208 may also be coupled to a combined modulator/demodulator 212.

In a particular example, the transceiver 208 may comprise a V2V transceiver configured to communicate with corresponding V2V transceivers of other vehicles 102, for example with a given distance (e.g., such as 100 meters, 250 meters, 500 meters, and the like, amongst other possibilities), using any suitable protocol.

Hence, the transceiver 208 and/or the communication interface 202 may enable a vehicle 102 and/or an associated mobile device 110, to communicate with other vehicles 102 and/or other mobile devices 110 associated with other vehicles 102, and/or the transceiver 208 and/or the communication interface 202 may enable a vehicle 102 and/or an associated mobile device 110, to communicate with the cloud server 116 (and/or the drone 118).

The controller 218 may include ports (e.g., hardware ports) for coupling to other suitable hardware components of the system 100.

The controller 218 may include one or more logic circuits, one or more processors, one or more microprocessors, one or more GPUs (Graphics Processing Units), and/or the controller 218 may include one or more ASIC (application-specific integrated circuits) and one or more FPGA (field-programmable gate arrays), and/or another electronic device.

In a particular example, the controller 218 may comprise one or more of: an In-Car Processor (ICP) of a vehicle 102; and/or a mobile processor of an associated mobile device 110.

In some examples, the controller 218 and/or the computing device 200 is not a generic controller and/or a generic device, but a device specifically configured to implement functionality for controlling vehicle-related functionality. For example, in some examples, the computing device 200 and/or the controller 218 specifically comprises a computer executable engine configured to implement functionality for controlling vehicle-related functionality.

The static memory 220 comprises a non-transitory machine readable medium that stores machine readable instructions to implement one or more programs or applications. Example machine readable media include a non-volatile storage unit (e.g., Erasable Electronic Programmable Read Only Memory (“EEPROM”), Flash Memory) and/or a volatile storage unit (e.g., random-access memory (“RAM”)). In the example of FIG. 2, programming instructions (e.g., machine readable instructions) that implement the functionality of the computing device 200 as described herein are maintained, persistently, at the memory 220 and used by the controller 218, which makes appropriate utilization of volatile storage during the execution of such programming instructions.

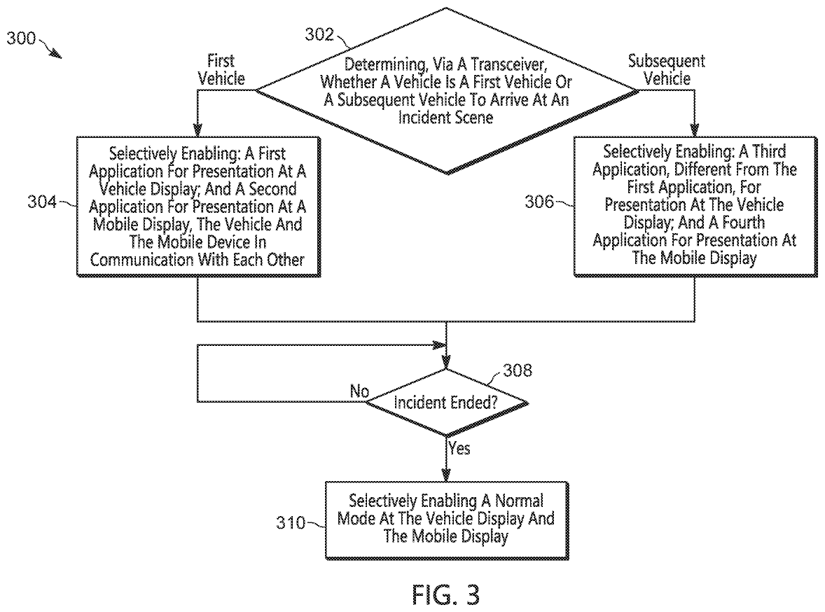

Regardless, it is understood that the memory 220 stores instructions corresponding to the at least one application 222 that, when executed by the controller 218, enables the controller 218 to implement functionality for controlling vehicle-related functionality, including, but not limited to, the blocks of the method set forth in FIG. 3.

As depicted, the memory 220 further stores instructions corresponding to the “normal” mode vehicle display application 131 and the mobile display application 132, as described herein. For example, the vehicle display application 131 may be selectively enabled (e.g., by the controller 218) for presentation at a vehicle display 108 in a “normal” mode, and the mobile display application 132 may be selectively enabled (e.g., by the controller 218) for presentation at a mobile display 112 in the “normal” mode.

In some examples, the applications 131, 132 (and/or corresponding modes of the displays 108, 112) may be selectively enabled when a vehicle 102 and/or an associated mobile device 110 arrives at the incident scene 114. In these examples, the controller 218 may be further enabled to determine when a vehicle 102 and/or an associated mobile device 110, arrives at an incident scene. Herein, a vehicle 102 “arriving” at an incident scene is understood to include the vehicle 102 being within a given distance of a location of an incident scene (e.g., 10 m, 20 m, 50 m, amongst other possibilities). Furthermore, a vehicle 102 “arriving” at an incident scene may further include the vehicle 102 being stopped within the given distance

As depicted, the memory 220 further stores instructions corresponding to at least one first application 231, at least one second application 232, at least one third application 233, and at least one fourth application 234.

The first application 231 may be selectively enabled (e.g., by the controller 218) for presentation at a vehicle display 108 when an associated vehicle 102 is a first vehicle to arrive at an incident scene, and/or when the vehicle display 108 is placed into a first vehicle support mode. Similarly, the second application 232 may be selectively enabled (e.g., by the controller 218) for presentation at an associated mobile display 112 when an associated vehicle 102 is the first vehicle to arrive at an incident scene, and/or when an associated mobile display 112 is placed into a first vehicle support mode. Indeed, the first application 231 and the second application 232 may be respectively selectively enabled in tandem for presentation at a vehicle display 108 and an associated mobile display 112, for example in a first vehicle support mode.

The third application 233 may be selectively enabled (e.g., by the controller 218) for presentation at a vehicle display 108 when an associated vehicle 102 is a subsequent vehicle to arrive at an incident scene, and/or when the vehicle display 108 is placed into a subsequent vehicle support mode. Similarly, the fourth application 234 may be selectively enabled (e.g., by the controller 218) for presentation at an associated mobile display 112 when an associated vehicle 102 is the subsequent vehicle to arrive at an incident scene, and/or when the associated mobile display 112 is placed into a subsequent vehicle support mode. Indeed, the third application 233 and the fourth application 234 may be respectively selectively enabled in tandem for presentation at a vehicle display 108 and an associated mobile display 112, for example in a subsequent vehicle support mode.

Examples of the applications 231, 232, 233, 234 are described in more detail below.

However, more than one of each of the applications 231, 232, 233, 234 may be provided, which of a particular application 231, 232, 233, 234 is implemented may depend on a type of an incident scene at which the vehicles 102 arrive.

For example, when the incident scene 114 comprises a traffic stop-type incident, a first application 231 selectively enabled at a vehicle display 108 of a first vehicle 102 to arrive at the incident scene 114 may comprise an LPR output application and a body-worn camera (BWC) output application (e.g., that provides streamed video of a body worn camera of a first responder that exits the first vehicle 102), and the remainder of the applications 232, 233, 234 may be selectively enabled accordingly. Such an example assumes that the first vehicle 102 to arrive at the incident scene 114 (e.g., the first vehicle 102-1) comprises a license plate reader and that an occupant of the first vehicle 102 operates a BWC. Furthermore, such an example illustrates that more than one first application 231 may be selectively enabled at a vehicle display 108; similarly, it is understood that more than one of any of the applications 231, 232, 233, 234 may be selectively enabled, for example for a given incident type.

In another example, when the incident scene 114 comprises a fire-related incident, a first application 231 selectively enabled at a vehicle display 108 of a first vehicle 102 to arrive at the incident scene 114 may comprise a fire hydrant location application, and the remainder of the applications 232, 233, 234 may be selectively enabled accordingly.

Particular examples of the applications 231, 232, 233, 234 according to an incident type are provided in Table 1, Table 2, Table 3, Table 4 and Table 5.

Furthermore, at least the third application 233 may be selectively enabled as a function of a determination of a respective first application 231 currently enabled at a respective vehicle display 108 of the first vehicle 102 to arrive at an incident scene. For example, returning to the traffic stop example, when the first application 231 currently enabled at a respective vehicle display 108 of the first vehicle 102 to arrive at the incident scene 114 comprises a BWC camera output application, a third application 233 selectively enabled at a respective vehicle display 108 of a subsequent vehicle 102 (e.g., the second vehicle 102-2) to arrive at the incident scene 114 may comprise a transcript application, which may output text of prior audio of the streamed video of the BWC camera output application, among other information.

It is further understood that one or more of the applications 231, 233 may be respectively the same or similar to the vehicle display application 131. Similarly, one or more of the applications 232, 234 may be respectively the same or similar to the mobile display application 132.

Indeed, in some examples, the memory 220 may store one vehicle display application and one mobile display application (e.g. such as the applications 131, 132, which, themselves, may be a same or similar application).

In these examples, a vehicle display 108 may be selectively enabled from a normal mode to a first vehicle support mode by changing a mode of a vehicle display application from a normal mode to a respective first vehicle support mode, when a respective vehicle 102 is a first vehicle to arrive at an incident scene. Similarly, a mobile display 112 may be selectively enabled from a normal mode to a first vehicle support mode by changing a mode of a mobile display application from a normal mode to a respective first vehicle support mode, when a respective vehicle 102 is a first vehicle to arrive at an incident scene.

Similarly in these examples, a vehicle display 108 may be selectively enabled from a normal mode to a subsequent vehicle support mode by changing a mode of the vehicle display application from a normal mode to a respective subsequent vehicle support mode, when a respective vehicle 102 is a subsequent vehicle to arrive at an incident scene. Similarly, a mobile display 112 may be selectively enabled from a normal mode to a subsequent vehicle support mode by changing a mode of the mobile display application from a normal mode to a respective subsequent vehicle support mode, when a respective vehicle 102 is a subsequent vehicle to arrive at an incident scene.

While details of the cloud server 116 and the drone 118 are not depicted, the cloud server 116 and the drone 118 may have components similar to the computing device 200 adapted, however, for the functionality thereof.

Attention is now directed to FIG. 3, which depicts a flowchart representative of a particular method 300 for controlling vehicle-related functionality. The operations of the method 300 of FIG. 3 correspond to machine readable instructions that are executed by the computing device 200, and specifically the controller 218 of the computing device 200. In the illustrated example, the instructions represented by the blocks of FIG. 3 are stored at the memory 220 for example, as the application 222. The method 300 of FIG. 3 is one way that the controller 218 and/or the computing device 200 and/or the system 100 may be configured. Furthermore, the following discussion of the method 300 of FIG. 3 will lead to a further understanding of the system 100, and its various components.

The method 300 of FIG. 3 need not be performed in the exact sequence as shown and likewise various blocks may be performed in parallel rather than in sequence. Accordingly, the elements of method 300 are referred to herein as “blocks” rather than “steps.” The method 300 of FIG. 3 may be implemented on variations of the system 100 of FIG. 1, as well.

It is furthermore understood that, when a vehicle 102 is a first vehicle to arrive at an incident scene, the method 300 may be implemented in association with a controller 218, and/or a computing device 200 associated with that vehicle 102, prior to other vehicles 102 arriving at the incident scene.

At a block 302, the controller 218, and/or the computing device 200, determines, via the transceiver 208 (e.g., and/or the communication interface 202), whether a vehicle 102 is a first vehicle 102 or a subsequent vehicle 102 to arrive at an incident scene (e.g., the incident scene 114). It is understood that the controller 218, and/or the computing device 200 may be components of one more of the vehicle 102 and an associated mobile device 110.

For example, the controller 218, and/or the computing device 200 may be further configured to determine, via the transceiver 208 (e.g., and/or the communication interface 202), whether the vehicle 102 is the first vehicle or the subsequent vehicle to arrive at the incident scene 114 by one or more of: communicating, via the transceiver 208 (e.g., and/or the communication interface 202), with other vehicles 102 at the incident scene 114; and communicating, via the transceiver 208 (e.g., and/or the communication interface 202), with the cloud server 116 configured to track vehicles at the incident scene 114.

For example, using a V2V transceiver, or another suitable transceiver, the controller 218, and/or the computing device 200 of a vehicle 102 may communicate with other vehicles 102, for example when they arrive at the incident scene 114, to determine a vehicle arrival order. For example, a vehicle 102 and/or an associated mobile device 110 may comprise a location determining device (e.g., such as a Global Positioning System (GPS) device) and may be using such a location determining device to track location as a function of time. Such respective locations as a function of time may be shared between the vehicles 102 and/or associated mobile devices 110 to determine respective vehicle arrival order at the incident scene 114.

Alternatively, or in addition, using any suitable transceiver, the controller 218, and/or the computing device 200 of a vehicle 102 may communicate with the cloud server 116, which may be communicating with the vehicles 102 to determine vehicle arrival order (e.g., by receiving, from the vehicle 102 and/or respective mobile devices 110, respective locations as a function of time of the vehicles 102). The cloud server 116 may provide respective indications to the vehicles 102 that indicate their respective vehicle arrival order at the incident scene 114.

Furthermore, a location of the incident scene 114 may be determined for example in the form of an address, GPS coordinates, and the like, when a first vehicle 102 that arrives at the incident scene 114 reports an incident of the incident scene 114, including the location, to the cloud server 116 and/or the other vehicles 102. Such a location may be stored at an incident report, which may be generated by the cloud server 116, and which may also include a type of the incident scene 114.

Hence, a vehicle 102 “arriving” at an incident scene is understood herein to include the vehicle 102 being within a given distance of a location of an incident scene (e.g., 10 m, 20 m, 50 m, amongst other possibilities). Furthermore, a vehicle 102 “arriving” at an incident scene may further include the vehicle 102 being stopped within the given distance. Indeed, the method 300 may initiate at the block 302 when the controller 218 and/or the computing device 200 determines that two vehicles 102 are within the given distance, and/or stopped at the given distance, from the incident scene 114.

When the vehicle 102 is a first vehicle to arrive at the incident scene 114 (e.g., a decision of “FIRST VEHICLE” at the block 302), at a block 304, the controller 218 and/or computing device 110 selectively enables: a first application 231 for presentation at a vehicle display 108 (e.g., of the vehicle 102); and a second application 232 for presentation at a mobile display 112 (e.g., of an associated mobile device 110).

In particular, at the block 304, the controller 218 and/or computing device 110 may change the vehicle display 108 and the mobile display 112 from an initial mode and/or a “normal” mode (including, but not limited to, a “mirror” mode), into a first vehicle support mode, for example by stopping implementation of the vehicle display application 131 and the mobile display application 131, and selectively enabling the first application 231 and the second application 232.

When the vehicle 102 is a subsequent vehicle to arrive at the incident scene 114 (e.g., a decision of “SUBSEQUENT VEHICLE” at the block 302), at a block 306, the controller 218 and/or computing device 110 selectively enables: a third application 233, different from the first application 231, for presentation at the vehicle display 108; and a fourth application 234 for presentation at the mobile display 112). Hence, in these examples, the respective vehicle displays 108 of a first vehicle 102 and a subsequent vehicle 102 to arrive at an incident scene 114 may have different applications selectively enabled.

In particular, at the block 306, the controller 218 and/or computing device 110 may change the vehicle display 108 and the mobile display 112 from an initial mode and/or a “normal” mode (including, but not limited to, a “mirror” mode), into a subsequent vehicle support mode, for example by stopping implementation of the vehicle display application 131 and the mobile display application 131, and selectively enabling the third application 233 and the fourth application 234.

After the block 304 and the block 306, a block 308 may be implemented at which the controller 218 and/or the computing device 200 determines whether an incident of the incident scene 114 has ended. For example, the vehicles 102 may disperse from the incident scene 114 such that the vehicles are no longer within the given distance from the incident scene 114, and/or the vehicles 102 may receive an indication from the cloud server 116 that the incident of the incident scene 114 has ended, among other possibilities. The block 308 may repeat (e.g., a “NO” decision occurs at the block 308) until the incident has ended (e.g., a “YES” decision occurs at the block 310), and a block 310 is implemented in which the controller 218 and/or the computing device 200 selectively enables a normal mode (e.g., a mirror mode) at the vehicle display 108 and the mobile display 112.

While not depicted, the method 300 may repeat after the block 310 a next time that a vehicle 102 associated with the controller 218 and/or the computing device 200 arrives at an incident scene and at least another vehicle 102 arrives at the incident scene.

Further aspects of the method 300 are next described.

In some examples, the second application 232 may be the same as the fourth application 234, such that the respective mobile displays 112 of a first vehicle 102 and a subsequent vehicle 102 to arrive at an incident scene 114 may have a same application selectively enabled. In other examples, the second application 232 may be different from the fourth application 234, such that the respective mobile displays 112 of a first vehicle 102 and a subsequent vehicle 102 to arrive at an incident scene 114 may have different applications selectively enabled.

It is understood that the first application 231, the second application 232, the third application 233, and the fourth application 234 may be default applications determined at least partially on vehicle arrival order at incident scenes.

It is further understood that the first application 231, the second application 232, the third application 233, and the fourth application 234 may be default applications that further depend on an incident type of the incident scene 114. For example, when the incident scene 114 comprises a traffic stop-type incident, the first application 231 may comprise a first arrival application associated with traffic stop-type incidents, with the remaining applications 232, 233, 234 selected accordingly. Similar, when the incident scene 114 comprises a fire-type incident, the first application 231 may comprise a first arrival application associated with fire-type incidents, with the remaining applications 232, 233, 234 selected accordingly.

However, the first application 231, the second application 232, the third application 233, and the fourth application 234 may be further modifiable or replaceable, for example automatically or via user input or manipulation, after a vehicle 102 arrives at an incident scene 114.

For example, using the example of a traffic stop, when the first application 231 comprises an LPR output application, the LPR output application may provide a license plate number acquired by an LPR reader of the first vehicle 102 to arrive at the incident scene 114, as well as at least a portion of information acquired in a license plate lookup via the cloud server 116, and the like, such as a name of a driver associated with the license plate number. However, such information may be expanded, for example upon selection of an actuatable electronic button of the first application 231, for example to also show an address of the driver associated with the license plate number, and the like.

Similarly, again using the example of a traffic stop, when the first application 231 initially comprises an LPR output application, when a subsequent vehicle 102 arrives at the incident scene 114, the LPR application may be replaced at the vehicle display 108 of the first vehicle 102 to arrive at the incident scene 114, by another first application 231, such as a camera output application showing video acquired by a camera of the subsequent vehicle 102 (e.g., which may be streamed between the vehicles 102 and/or via the cloud server 116).

In another example, and again using the example of a traffic stop, when the first application 231 initially comprises an LPR output application, when an occupant 104, 106 of the first vehicle 102 to arrive the incident scene 114, exits the first vehicle 102 and enables a BWC, the LPR application may be replaced at the vehicle display 108 of the first vehicle 102 to arrive at the incident scene 114, by another first application 231, such as a BWC output application showing video acquired by the BWC of the occupant that exited the first vehicle 102.

Indeed, any of the applications 231, 232, 233, 234 may be modified or replaced in any suitable manner.

Alternatively, or in addition, more than one respective application 231, 232, 233, 234 may be selectively enabled at a suitable respective display 108, 112.

For example, again using the example of a traffic stop, when the first application 231 initially comprises an LPR output application, when an occupant 104, 106 of the first vehicle 102 to arrive the incident scene 114, exits the first vehicle 102 and enables a BWC, a BWC output application showing video acquired by the BWC of the occupant that exited the first vehicle 102 may also be enabled at the vehicle display 108 of the first vehicle 102.

Furthermore, the method 300 may further comprise, the controller 218 and/or the computing device 200: controlling the mobile display 112 to change based on interactions with the vehicle display 108; and control the vehicle display 108 to change based on respective interactions with the mobile display 112.

For example, and again using the example of a traffic stop, when the first application 231 enabled at a vehicle display 108 of the first vehicle 102 to arrive at the incident scene 114 includes a BWC output application showing video acquired by the BWC of an occupant that exited the first vehicle 102, the first application 231 may include an electronic button that, when actuated, controls the mobile display 112 of the associated mobile device 110 to also display the video acquired by the BWC.

In yet another example, and again using the example of a traffic stop, when the second application 232 enabled at a mobile display 112 of the first vehicle 102 to arrive at the incident scene 114 includes an incident application, for example showing a list of incidents being tracked by the cloud server 116 (e.g., including, but not limited to, an incident of the incident scene 114), the second application 232 may include an electronic button that, when actuated, controls the vehicle display 108 to display the list of incidents and/or a map of the incidents. Continuing with this example, the second application 232 may include another electronic button that, when actuated, controls the mobile display 112 to display a map of the incidents.

It is furthermore understood that, when a vehicle 102 is a first vehicle 102 to arrive at an incident scene 114, the method 300 may be implemented in association with a controller 218, and/or a computing device 200 associated with that vehicle 102, prior to other vehicles 102 arriving at the incident scene 114. In these examples, a “FIRST VEHICLE DECISION” results at the block 302, and the block 304 is implemented.

It is furthermore understood that, when a vehicle 102 is a subsequent vehicle to arrive at an incident scene 114, the method 300 may be implemented in association with a controller 218, and/or a computing device 200 associated with that vehicle 102, after at least one other vehicles 102 arrives at the incident scene 114. In these examples, a “SUBSEQUENT DECISION” results at the block 302, and the block 306 is implemented.

Furthermore, the method 300 may be initiated at any suitable time including, but not limited to, when a vehicle 102 arrives at the incident scene 114 (e.g., as determined via the controller 218 and/or the vehicle 102) and/or when a vehicle 102 reports the incident scene 114 to the cloud server 116 (e.g., as determined via the controller 218 and/or the vehicle 102), and the like.

In some examples, the method 300 may further comprise, a controller 218 and/or a computing device 200 of the first vehicle 102-1, in response to determining that the first vehicle 102-1 is the first vehicle 102-1 to arrive at the incident scene 114 (e.g., a “FIRST VEHICLE” decision at the block 302 of the method 300), communicating with a controller 218 and/or a computing device 200 of a subsequent vehicle 102 to arrive at the incident scene 114 (e.g., such as the second vehicle 102-2) to provide one or more of: an indication (e.g., such as an address, GPS coordinates, and the like) of a stop location; and directions to the stop location. Such a communication may occur via the direct V2V wireless communication link 113, and/or in any other suitable manner. The stop location may be received at an input device of one or more of a vehicle display 108-1 and the mobile display 112-1 of the first vehicle 102-1, and/or the controller 218 and/or the computing device 200 of the first vehicle 102-1 may determine the stop location, such as less than the given distance over which the direct V2V wireless communication link 113 is operable, another given distance (e.g., 10 m, 20 m, 25 m, amongst other possibilities) from the incident scene 114, the like.

In some examples, the method 300 may further comprise, the controller 218 and/or the computing device 200, when a vehicle 102 is the first vehicle to arrive at the incident scene 114: receiving input for one or more of the first application 231 and the second application 232; and communicating (e.g., via the transceiver 208 and/or the communication interface 202) with a subsequent vehicle to arrive at the incident scene 114 to cause a controller 218 and/or computing device 200 of the subsequent vehicle to arrive at the incident scene 114 to update one or more of the third application 233 and the fourth application 234 based on the input. Put another way, input received for one or more of the first application 231 and the second application 232 at the first vehicle 102-1 may cause updates to one or more of the third application 233 and the fourth application 232 at the first vehicle 102-1.

Alternatively, or in addition, the method 300 may further comprise, the controller 218 and/or the computing device 200, when a vehicle 102 is the subsequent vehicle to arrive at the incident scene 114: receiving respective input for one or more of the third application 233 and the fourth application 234; and communicating (e.g., via the transceiver 208 and/or the communication interface 202) with a first vehicle to arrive at the incident scene 114 to cause a controller 218 and/or computing device 200 of the first vehicle to arrive at the incident scene 114 to update one or more of the first application 231 and the second application 232 based on the input. Hence, for example, input received via an application at one vehicle 102 may cause an application at another vehicle 102 to be updated.

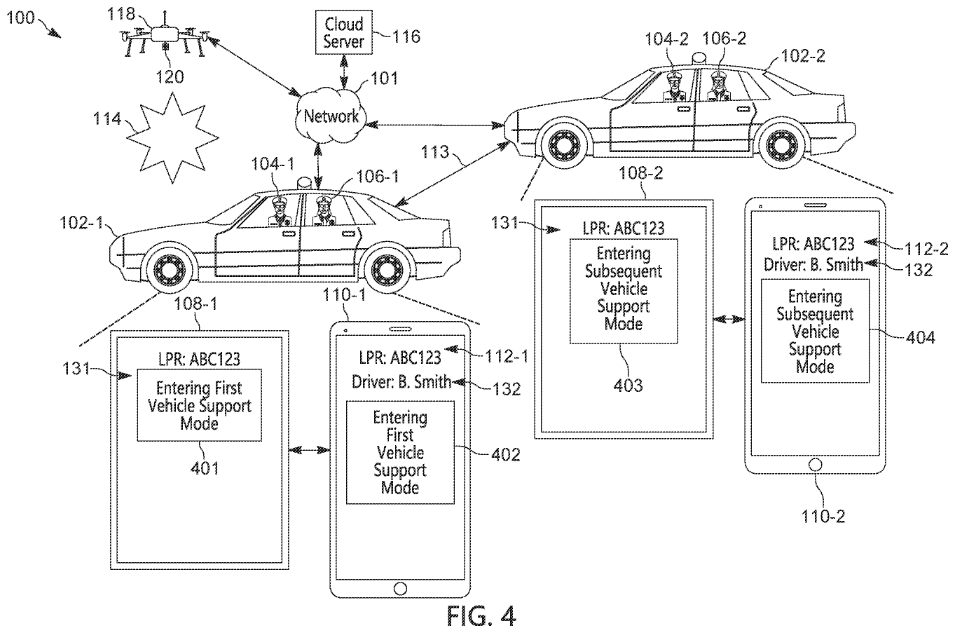

Attention is next directed to FIG. 4 and FIG. 5, which depict an example of aspects of the method 300. FIG. 4 and FIG. 5 are substantially similar to FIG. 1, with like components having like numbers.

With attention first directed to FIG. 4, it is understood that the displays 108, 112 are initially in the aforementioned normal mode. However, it is further understood that the first vehicle 102-1 is the first vehicle to arrive at the incident scene 114, and the second vehicle 102-2 is a subsequent vehicle 102-2 to arrive at the incident scene 114. As such, a respective computing device 200 of the first vehicle 102-1 determines that the first vehicle 102-1 is the first vehicle to arrive at the incident scene 114 (e.g., a “FIRST VEHICLE” decision at the block 302 of the method 300), and a respective computing device 200 of the second vehicle 102-2 determines that the second vehicle 102-2 is a subsequent vehicle to arrive at the incident scene 114 (e.g., a “SUBSEQUENT VEHICLE” decision at the block 302 of the method 300).

As such, in particular depicted examples, a respective computing device 200 of the first vehicle 102-1 may control the first vehicle display 108-1 to provide a notification 401 that the first vehicle display 108-1 is being placed in a first vehicle support mode (e.g., as depicted, via text “Entering First Vehicle Support Mode”).

Similarly, the respective computing device 200 of the first vehicle 102-1 may control the first mobile display 112-1 to provide a notification 402 that the first vehicle display 108-1 is being placed in a first vehicle support mode (e.g., as depicted, via text “Entering First Vehicle Support Mode”).

Similarly, a respective computing device 200 of the second vehicle 102-2 may control the second vehicle display 108-2 to provide a notification 403 that the second vehicle display 108-2 is being placed in a subsequent vehicle support mode (e.g., as depicted, via text “Entering Subsequent Vehicle Support Mode”).

Similarly, the respective computing device 200 of the second vehicle 102-2 may control the second mobile display 112-2 to provide a notification 404 that the second vehicle display 108-2 is being placed in a subsequent vehicle support mode (e.g., as depicted, via text “Entering Subsequent Vehicle Support Mode”).

While not depicted, the notifications 401, 402, 403, 404 may be provided with one or more electronic buttons, and the like, to accordingly accept or reject being placed into the first or subsequent vehicle support modes, and the like. In these examples, an occupant 104, 106 of a vehicle 102 may actuate a suitable electronic button to cause respective displays 108, 112 to accordingly enter the first or subsequent vehicle support modes. Alternatively, or in addition, after the notifications 401, 402, 403, 404 are provided for a given time period (e.g., 1 second, 2 seconds 5 seconds, amongst other possibilities), respective displays 108, 112 may be accordingly selectively controlled from a normal mode into a first or subsequent vehicle support mode, as is next described with respect to FIG. 5. However, when an occupant 104, 106 of a vehicle 102 actuates a suitable electronic button to reject entering a first or subsequent vehicle support mode, respective displays 108, 112 may remain in the normal mode; indeed, in some of these examples, when a suitable electronic button to reject entering a first or subsequent vehicle support mode is received at any of the respective displays 108, 112 of only two vehicles 102 at the incident scene 114, displays 108, 112 of both of vehicles 102 may remain in the normal mode. However, as long as suitable electronic buttons at least of respective displays 108, 112 of the first vehicle 102-1 and one subsequent vehicle 102-2 are accordingly actuated to enter a first or subsequent vehicle support mode, the respective displays 108, 112 are accordingly placed into a first or subsequent vehicle support mode.

Attention is next directed to FIG. 5, which is understood to follow from FIG. 4. Similar to FIG. 4, in FIG. 5 it is understood that the first vehicle 102-1 is the first vehicle 102-1 to arrive at the incident scene 114, and the second vehicle 102-2 is a subsequent vehicle 102-2 to arrive at the incident scene 114.

As such, a controller 218 and/or a computing device 200 of the first vehicle 102-1 has determined that the first vehicle 102-1 is the first vehicle 102-1 to arrive at the incident scene 114 (e.g., a “FIRST VEHICLE” decision at the block 302 of the method 300), as previously described. Similarly, a controller 218 and/or a computing device 200 of the second vehicle 102-2 has determined that the second vehicle 102-2 is the subsequent vehicle 102-2 to arrive at the incident scene 114 (e.g., a “SUBSEQUENT VEHICLE” decision at the block 302 of the method 300), as previously described

In FIG. 5, it is further understood that the first occupant 104-1 of the first vehicle 102-1 (e.g., now referred to as an exited occupant 104-1) has exited the first vehicle 102-1 with a BWC 502, and the BWC 502 is streaming video of the incident scene 114 to one or more of the cloud server 116, the first vehicle 102-1 and the subsequent vehicle 102-2.

In FIG. 5, it is further understood that the drone 118 has been launched, is hovering over the incident scene 114 and is streaming video of the incident scene 114 (e.g., from the camera 120) to one or more of the cloud server 116, the first vehicle 102-1 and the subsequent vehicle 102-2.

Furthermore, in the depicted example, the incident scene 114 may comprise a traffic stop. Hence, while for simplicity, the incident scene 114 continues to be shown generically as a star in FIG. 5, it is understood that the incident scene 114 may comprise a vehicle and a driver who may have exited the vehicle of the incident scene 114 as described hereafter. Indeed, such a vehicle and driver will be described with respect to video streamed from the BWC 502 and the drone 118.

With attention first directed to the vehicle display 108-1 of the first vehicle 102-1 to arrive at the incident scene 114, the first application 231 selectively enabled at the vehicle display 108-1 (e.g., at the block 304 of the method 300) comprises an LPR application and a BWC output application. For example, at the vehicle display 108-1, the LPR application includes LPR data of a license plate number (e.g., “ABC123”) and a name of a driver (e.g., “B. Smith”) associated with the license plate number. The BWC output application includes a window 504 showing video streamed from the BWC 502; as such the video of the window 504 shows a vehicle of the traffic stop of the incident scene 114 and a driver that exited the vehicle. The video streamed from the BWC 502 may be received at the vehicle 102-1 via the cloud server 116 via the network 101, and/or the transceiver 208 associated with vehicle 102-1; in some specific examples, the BWC 502 may communicate directly with the transceiver 208 associated with vehicle 102-1 via a local communication link.

With attention next directed to the mobile display 112-1 of the associated mobile device 110-1, the second application 232 selectively enabled at the mobile display 112-1 (e.g., at the block 304 of the method 300) comprises an LPR application (e.g., similar to the first application 231) and an incident list application. For example, at the mobile display 112-1, the LPR application includes the same LPR data provided at the vehicle display 108-1, but expanded to include an address (e.g., “123 Main St.”) of the driver associated with the license plate number. The incident list application includes a list of incidents (e.g., downloaded from the cloud server 116 by the incident list application) that the cloud server 116 is tracking.

Returning to the vehicle display 108-1, the LPR application of the first application 231 includes an electronic button 506 (e.g., “Expand”) that, when actuated, causes the LPR application of the first application 231 to provide expanded LPR data, such as the address (e.g., “123 Main St.”) of the driver associated with the license plate number.

Furthermore, at the vehicle display 108-1, the BWC output application of the first application 231 includes an electronic button 508A (e.g., “Show On Mobile”) that, when actuated, causes the window 504 to be provided at the mobile display 112-1.

At the vehicle display 108-1, the BWC output application of the first application 231 includes an electronic button 508B (e.g., “Show On Subsequent Vehicle Display”) that, when actuated, causes the window 504 to be provided at the vehicle display 108-2 of the subsequent vehicle 102-2, for example via the direct V2V wireless communication link 113. In examples where there is more than one subsequent vehicle 102, actuation of the electronic button 508B may cause a menu, and the like, to be provided at the vehicle display 108-1 of the first vehicle 102-1, the menu providing a list of subsequent vehicles 102 for selection, to select at which subsequent vehicle 102 the window 504 is to be provided. Alternatively, or in addition, actuation of the electronic button 508B may cause the window 504 to be provided at respective vehicle displays 108 of all the subsequent vehicles 102. Alternatively, or in addition, actuation of the electronic button 508B may cause options to be provided for selecting whether the window 504 is to be provided at a respective vehicle display 108 or a respective mobile display 112 of a subsequent vehicle 102. Alternatively, or in addition, actuation of the electronic button 508B may cause options to be provide at a display 108, 112 of a subsequent vehicle 102 for accepting or rejecting providing of the window 504 thereupon. Regardless, the electronic button 508A illustrates that input received at the vehicle display 108-1 and/or the mobile display 112-1, for one or more of the first application 231 and the second application 232 at the first vehicle 102-1, may cause updates to one or more of the third application 233 and the fourth application 234 at the second vehicle 102-2.

Returning to the mobile display 112-1, the incident list application of the second application 232 includes a first electronic button 510 (e.g., “Show On Map”) that, when actuated, causes the incident list application of the second application 232 to provide a map showing the addresses of the incidents of the list. Similarly, the incident list application of the second application 232 includes a second electronic button 512 (e.g., “Show Map On Vehicle”) that, when actuated, such a map to be provided at the vehicle display 108-1.

With attention next directed to the vehicle display 108-2 of the subsequent vehicle 102-2 to arrive at the incident scene 114, the third application 233 selectively enabled at the vehicle display 108-2 (e.g., at the block 306 of the method 300) comprises a drone output application and a transcript application. The drone output application of the third application 233 includes a window 514 showing video streamed from the drone 118 as such the video of the window 504 shows the vehicle of the traffic stop of the incident scene 114 and the driver that exited the vehicle from the point-of-view of the drone 118 (e.g., overhead), as well as the exited occupant 104-1 (e.g., also from overhead).

At the vehicle display 108-2, the drone output application of the third application 233 includes an electronic button 515 (e.g., “Show On First Vehicle Display”) that, when actuated, causes the window 514 to be provided at the vehicle display 108-1 of the first vehicle 102-1, for example via the direct V2V wireless communication link 113. Alternatively, or in addition, actuation of the electronic button 515 may cause options to be provided for selecting whether the window 514 is to be provided at the vehicle display 108-1 or the mobile display 112-1 of the first vehicle 102-1. Alternatively, or in addition, actuation of the electronic button 515 may cause options to be provide the vehicle display 108-1 or the mobile display 112-1 of the first vehicle 102-1 for accepting or rejecting providing of the window 514 thereupon. Regardless, the electronic button 515 illustrates that input received at the vehicle display 108-2 (e.g., and/or the mobile display 112-2) for one or more of the third application 233 and the fourth application 234 may cause updates to one or more of the first application 231 and the second application 232 at the first vehicle 102-1.

The transcript application of the third application 233 includes text of prior audio of the streamed video of the BWC 502 and/or the BWC output application of the first application 231. For example, the transcript application may receive the streamed video from the BWC 502, and convert the audio of the streamed video into text, that is provided at the vehicle display 108-2 of the subsequent vehicle 102-2. Alternatively, and/or in addition, such text may be generated by the cloud server 116 and downloaded by the transcript application.

As depicted, such text includes text of audio acquired by the BWC 502 prior to arrival of the subsequent vehicle 102-2 at the incident scene 114 (e.g., and labeled “Prior Audio of BWC of 01”, where “1” indicates “Officer 1”, the exited occupant 104-1 that exited the first vehicle 102-1). For example such text of audio acquired prior to arrival of the subsequent vehicle 102-2 at the incident scene 114 indicates that the exited occupant 104-1 (e.g., “01”) asked the driver of the vehicle at the traffic stop to exit his vehicle (e.g., “Sir, exit the vehicle”), the driver (e.g., “Suspect”) replied he would do that (e.g., “Sure, will do”), and the exited occupant 104-1 subsequently asked the driver to keep this hands visible (e.g., “Keep hands visible please”). Such text further includes live audio being currently acquired by the BWC (e.g., and labeled “Live Audio”), and includes the driver of the vehicle at the traffic stop agreeing to keep his hands visible (e.g., “Yes Officer”).

With attention next directed to the mobile display 112-2 of the associated mobile device 110-2, the fourth application 234 selectively enabled at the mobile display 112-2 (e.g., at the block 306 of the method 300) comprises a drone control application, and an on-scene application.

The drone control application (e.g., a drone interface) of the fourth application 234 includes controls to control throttle, pitch, yaw and roll of the drone and zoom of the drone camera 120. In some examples, the drone interface of the fourth application 234 may be provided at the mobile display 112-2 of the subsequent vehicle 102-2 only after a computing device 200 of the first vehicle 102-1 and/or the mobile device 110-1 is queried to determine that the first vehicle 102-1 is not providing a drone interface (which may be controlled by the second occupant 106-1 that remains in the first vehicle 102-1). Put another way, computing devices 200 of the vehicles 102 and/or the mobile devices 110 may communicate to ensure that only one of the vehicles and/or mobile devices 110 is controlling the drone 118.

The on-scene application of the fourth application 234 includes a list of the police officers currently “on scene” at the incident scene 114 (e.g., “01: Officer Jones” and “02: Officer Aziz” (e.g., the second occupant 106-1), which may be retrieved from the cloud server 116. The on-scene application further includes a link 516 to the streamed video of the BWC 502 that, when actuated, may cause window, similar to the window 504, to be provided at the mobile display 112-2 (and/or the vehicle display 108-2), showing the video from the BWC 502.

Hence, it is apparent from the example of FIG. 5 that the applications 231, 232, 233, 234 may be provided in a manner to efficiently control functionality at the vehicles 102 and/or manage processing of data at the vehicles 102. For example, as the exited occupant 104-2 and the associated second occupant 106-1 remaining in the vehicle 102-1 may be first at the incident scene 114, due to the vehicle 102-1 arriving first at the incident scene 114, the exited occupant 104-1 and the associated second occupant 106-1 may be occupied with managing the incident scene 114. Hence, rather than provide drone controls via the first vehicle 102-1 and/or the associated mobile device 110-1, such drone controls are provided via the second vehicle 102-2 and/or the associated mobile device 110-2 for supporting the first vehicle 102-1, for example as supervised by the first occupant 104-2 and/or the second occupant 106-2 of the subsequent vehicle 102-2. Similarly, the video display 108-2 is controlled to show text of historical audio of the BWC 502 so that the first occupant 104-2 and/or the second occupant 106-2 of the subsequent vehicle 102-2 are informed of an historical and current state of the incident scene 114; such a historical and current state of the incident scene 114 may be generally useless to the exited occupant 104-1 and the associated second occupant 106-1 of the first vehicle 102-1 and processing thereof may hence be a waste of processing resources.

Indeed, the applications 231, 232, 233, 234 may include any other suitable information, which may include, but is not limited to, a map and/or locations of the occupants of the vehicles 102 (e.g., determined from worn mobile devices, such as the BWC 502, and the like), tasks associated with the occupants of the vehicles 102 (e.g., which may be accessed via an incident report associated with the incident scene 114), and the like, video from closed circuit cameras at or near the incident scene 114 (e.g., and the cloud server 116 may have access to video from such one or more closed circuit cameras), information from biometric, or other sensors, associated with occupants of the vehicles 102, floorplans of buildings at or near the incident scene 114 (e.g., as provided by the cloud server 116, and which may include, ingress/egress points, evacuation status, and the like of floors of the buildings).

In some examples, the applications 231, 232, 233, 234 may include a form application, for example for filling in a form that may be added to an incident report for the incident of the incident scene 114, and the like. Such a form may be at least partially populated based on contextual information available to one or more computing devices of the vehicles 102 and/or the cloud server 116, such as a type of the incident, identifiers of occupants 104, 106 and/or vehicles 102 present and/or dispatched to the incident, and the like, information from an LPR, and the like, amongst other possibilities. The form of the form application may be further filled in via an occupant 104, 106 interacting with the form application, for example to add observations, and the like of an occupant 104, 106.

In a particular example, video and/or audio (e.g., historical and/or currently streamed by cameras and/or microphones associated with a vehicle 102) acquired in association with one vehicle 102 may be provided at another vehicle 102, and vice versa. In such examples, video acquired in association with the first vehicle 102 to arrive at the incident scene 114 may be provided in an application 233, 234 at a subsequent vehicle 102 to arrive at the incident scene 114, and video acquired in association with the subsequent vehicle 102 to arrive at the incident scene 114 may be provided in an application 231, 232 at the first vehicle 102 to arrive at the incident scene 114.

Furthermore, when there is more than one subsequent vehicle 102 to arrive at the incident scene 114, such subsequent vehicles 102 may selectively enable respective same third and fourth applications 233, 234, or one or more of respective third and fourth applications 233, 234 may be different for each subsequently arriving vehicle 102. For example, a third application 233 selectively enabled at one subsequent vehicle 102 may comprise a BWC output application, and a third application 233 selectively enabled at another subsequent vehicle 102 may comprise a closed camera output application, for example providing video from one or more closed circuit cameras at, or near, the incident scene 114.

Furthermore, in some very particular examples, the first and third applications 231, 233 may be similar and/or of the same type, but selectively controlled to provide different information content (e.g., both the first and third applications 231, 233 may comprise BWC output applications, but the BWC output application of the first application 231 may provide video associated with a subsequent vehicle 102 to arrive at the incident scene 114, and the BWC output application of the third application 233 may provide video associated with a first vehicle 102 to arrive at the incident scene 114, among other possibilities).

In some further very particular examples, all the applications 231, 232, 233, 234 may be similar and/or of the same type, but selectively controlled to provide different information content in a first vehicle support mode or a subsequent vehicle support mode. Put another way, a single application, such as the application 222, may comprise all the applications 231, 232, 233, 234 (as well as the applications 131, 132), and/or functionality thereof, and the single application may be operated in different modes as described herein.

While particular examples of the applications 231, 232, 233, 234 are described with respect to the traffic stop of FIG. 5, other applications 231, 232, 233, 234 for a traffic stop are within the scope of the present specification.

For example, Table 1 provides different examples of applications 231, 232, 233, 234 for a traffic stop:

TABLE 1
Traffic Stop Application Examples

| | |
|---|---|
| Application 231 | Application 232 |
| (First Vehicle Display 108-1) | (First Mobile Display 112-1) |
| LPR results | An expanded version of: LPR |
| Driver information | results; and/or driver Information |
| | Incident list |
| | Map View of Incidents, |
| | and the like |
| Application 233 | Application 234 |
| (Subsequent Vehicle | (Subsequent Mobile |
| Display 108-2) | Display 112-2) |
| Drone video of stopped vehicle | An expanded version of: drone |
| (e.g., optionally, only when | information; prior arriving officer’s |
| the vehicle stopped) | BWC info; and/or other available |
| Prior arriving officer(s)’ BWC | transcripts available, etc. |
| when out of vehicle | Drone control |
| Transcription of audio | Prior arriving officer BWC |
| (ambient and/or | selection list |
| BWC) from prior officers | Incident list |
| | Map view of Incidents, |
| | and the like |

Furthermore, the applications 231, 232, 233, 234 may be selected based on a type of incident. For example, Table 2 provides different examples of applications 231, 232, 233, 234 for a commercial (non-fire) 911 (e.g., police) dispatch to a location:

TABLE 2
Commercial (Non-Fire) 911 Dispatch Application Examples

| | |
|---|---|
| Application 231 | Application 232 |
| (First Vehicle Display 108-1) | (First Mobile Display 112-1) |
| Address/Business lookup/results | Other nearby addresses |
| 911 Call Transcript | Other 911 transcripts for earlier |
| | or nearby incidents, etc. |
| | Incident list |
| | Map view of incidents, |
| | and the like |
| Application 233 | Application 234 |
| (Subsequent Vehicle | (Subsequent Mobile |
| Display 108-2) | Display 112-2) |
| Drone video of business location | An expanded version of: drone |
| Access to internal business/ | information; list of ingress/egress |
| location fixed video | locations; fixed video available; |
| Access to external business/ | and/or other transcripts |
| location fixed video | available, etc. |
| Prior arriving officer(s)’ BWC | List of locations not already |
| if out of vehicle | checked/present of prior officer |
| List of locations (internal and/or | (actionable by 911 call center |
| external) already checked/present | and/or can self-assign) |
| of prior officer (canvassing, etc.) | Drone control |
| Floorplans, ingress/egress | Prior arriving officer BWC |
| points, etc. Transcription of audio | selection list |
| (ambient and/or | Incident list |
| BWC) from prior officers | Map view of Incidents, |
| | and the like |

In another example, Table 3 provides different examples of applications 231, 232, 233, 234 for a residential (non-fire) 911 (e.g., police) dispatch to a location:

TABLE 3
Residential (Non-Fire) 911 Dispatch Application Examples

| | |
|---|---|
| Application 231 | Application 232 |
| (First Vehicle Display 108-1) | (First Mobile Display 112-1) |
| Address/Business lookup/results | Other nearby addresses |
| 911 Call Transcript | Other 911 transcripts for earlier |
| Resident information/background | or nearby incidents, etc. |
| check and/or information/prior | Resident information/background |
| incident check | check/info for nearby addresses |
| | Incident List |
| | Map View of incidents, |
| | and the like |
| Application 233 | Application 234 |
| (Subsequent Vehicle | (Subsequent Mobile |
| Display 108-2) | Display 112-2) |
| 911 records of prior | An expanded version of: list of |
| visits to location | ingress/egress; fixed |
| List of locations (internal and/or | video available; and/or other |
| external) already checked/present | transcripts available, etc. |
| of prior officer (canvassing, etc.) | List of locations not already |
| Floorplans: Locations of ingress/ | checked/present of prior officers |
| egress points, etc.; those | (actionable/can self-assign) |
| covered and those not | LPR results of recent scans |
| yet covered | near the location |
| Vehicle information | Vehicle information associated |
| associated with resident(s) | with known associates |
| Vehicle location(s) if nearby | of resident(s); and |
| Transcription of | vehicles location if nearby |
| audio (ambient | Nearby residential/RingTM type |
| and/or BWC) | cameras available (e.g., and with |
| from prior officers | indication of whether streamable |

In another example, Table 4 provides different examples of applications 231, 232, 233, 234 for a moving/caravan (e.g., police) incident (e.g., such as a presidential caravan), where there are at least two subsequent vehicles 102, such as at least one second subsequent vehicle 102 and a last subsequent vehicle 102:

TABLE 4
Moving Incident (e.g., Caravan) Application Examples

| | |
|---|---|
| Application 231 | Application 232 |
| (First Vehicle Display 108-1) | (First Mobile Display 112-1) |
| Video streamed from rear/last | List and/or location of other |
| vehicle Local area map/ | video streams available from |
| dynamically updated | other caravan vehicles |
| | LPR hot hits |
| | List of other officers/first |
| | responders in caravan and/ |
| | or approaching caravan |
| | ETA to destination |
| | Incident list |
| | Available drones (currently |
| | streaming or not, actionable |
| | to activate) to caravan |
| Application 233 | Application 234 |
| (Second/Later | (Second/Later |
| Subsequent Vehicle | Subsequent Mobile |
| Display 108-2) | Display 112-2) |
| Video stream from front/ | List and/or location of other |
| first and rear/last vehicle | video streams available from |
| Local area map/dynamically | other caravan vehicles |
| updated | LPR hot hits |
| | List of other officers/first |
| | responders in caravan and/ |
| | or approaching caravan |
| | ETA to destination |
| | Incident list |
| | Available drones (currently |
| | streaming or not, actionable |
| | to activate) to caravan |
| Application 233 | Application 234 |
| (Last Subsequent Vehicle | (Last Subsequent Mobile |
| Display 108-2) | Display 112-2) |
| Video stream from front/ | Same As Applications 234 For |
| first and rear/last vehicle | Second/Later Subsequent |
| Otherwise Same As | Vehicle |
| Applications 233 For Second/ | |
| Later Subsequent Vehicle | |

In another example, Table 5 provides different examples of applications 231, 232, 233, 234 for a 911 fire dispatch to a location:

TABLE 5
Fire 911 Dispatch Application Examples

| | |
|---|---|
| Application 231 | Application 232 |
| (First Vehicle Display 108-1) | (First Mobile Display 112-1) |
| Address/Business lookup/results | Other nearby addresses |
| 911 Call Transcript | Other 911 transcripts for earlier or |
| Fire hydrant locations | nearby incidents, etc. |
| | Incident List |
| | Map View of incidents, |
| | fire hydrants, actionable/ |
| | self-assigned locations for |
| | firefighters and the like |
| Application 233 | Application 234 |
| (Subsequent Vehicle | (Subsequent Mobile |
| Display 108-2) | Display 112-2) |
| Drone video of business location | An expanded version of: drone |
| Access to internal | information; and/or list of ingress/ |
| business/location fixed video | egress fixed video available; and/ |
| Access to external | or other transcripts available, etc. |
| business/location fixed video | List of locations not already |
| Prior arriving firefighter(s)’ BWC | checked/present of prior firefighter |
| if out of vehicle | (actionable/can self-assign) |
| Prior arriving firefighter(s)’ sensor | Access control information |
| info (temperatures, biometrics, | (commercial or residential) for |
| etc., e.g., if out of vehicle | residents of location |
| List of locations (internal and/or | Drone control |
| external) already checked/ | Prior arriving firefighter BWC |
| present of prior firefighter | selection list |
| (canvassing, etc.) | Incident list |
| Floorplans: Locations of | Map view of Incidents, |
| evacuated floors/personnel/etc. | and the like |
| and unevacuated | |
| floors/personnel/etc.; | |
| ingress/egress points, etc. | |
| Transcription of audio (ambient | |
| and/or BWC) | |
| from prior firefighters | |

While Table 1, Table 2, Table 3, Table 4 and Table 5 have been described with respect to the applications 231, 232, 233, 234, it is understood that the types of information described in Table 1, Table 2, Table 3, Table 4 and Table 5 may be provided in one or more same applications, operating in a first vehicle support mode or a subsequent vehicle support mode. Indeed, in particular, with respect to Table 5, it is understood that a subsequent vehicle support mode may comprise either a non-last subsequent vehicle support mode or a last subsequent vehicle support mode.

As should be apparent from this detailed description above, the operations and functions of electronic computing devices described herein are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, cannot control displays, and the like).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”′, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together). Similarly the terms “at least one of” and “one or more of′, without a more limiting modifier such as “only one of′, and when applied herein to two or more subsequently defined options such as “at least one of A or B”, or “one or more of A or B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context, in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

Furthermore, descriptions of one processor and/or controller and/or device and/or engine, and the like, configured to perform certain functionality is understood to include, but is not limited to, more than one processor and/or more than one controller and/or more than one device and/or more than one engine, and the like performing such functionality.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A system comprising:
a vehicle comprising: a vehicle display;
a mobile device comprising: a mobile display, the vehicle and the mobile device communicatively coupled to each other;
a transceiver; and
at least one controller configured to:
determine, via the transceiver, whether the vehicle is a first vehicle or a subsequent vehicle to arrive at an incident scene;
when the vehicle is the first vehicle to arrive at the incident scene:
selectively enable: a first application for presentation at the vehicle display; and a second application for presentation at the mobile display; and
when the vehicle is the subsequent vehicle to arrive at the incident scene:
selectively enable: a third application, different from the first application, for presentation at the vehicle display; and a fourth application for presentation at the mobile display.

2. The system of claim 1, wherein the at least one controller comprises one or more of:
an In-Car Processor (ICP) of the vehicle; and
a mobile processor of the mobile device.

3. The system of claim 1, wherein the transceiver comprises a vehicle-to-vehicle transceiver.

4. The system of claim 1, wherein:
the second application is a same as the fourth application; or
the second application is different from the fourth application.

5. The system of claim 1, wherein the at least one controller is further configured to determine, via the transceiver, whether the vehicle is the first vehicle or the subsequent vehicle to arrive at the incident scene by one or more of:
communicating, via the transceiver, with other vehicles at the incident scene; and
communicating, via the transceiver, with a cloud server configured to track vehicles at the incident scene.

6. The system of claim 1, wherein the at least one controller is further configured to:
control the mobile display to change based on interactions with the vehicle display; and
control the vehicle display to change based on respective interactions with the mobile display.

7. The system of claim 1, wherein the first application, the second application, the third application, and the fourth application are default applications determined at least partially on vehicle arrival order at incident scenes.

8. The system of claim 7, wherein the first application, the second application, the third application, and the fourth application are further modifiable or replaceable after the vehicle arrives at the incident scene.

9. The system of claim 1, wherein the at least one controller is further configured to:
when the vehicle is the subsequent vehicle to arrive at the incident scene:
selectively enable the third application as a function of a determination of a respective first application currently enabled at a respective vehicle display of the first vehicle.

10. The system of claim 1, wherein the at least one controller is further configured to:
when the vehicle is the first vehicle to arrive at the incident scene:
receive input for one or more of the first application and the second application; and
communicate, via the transceiver with the subsequent vehicle to arrive at the incident scene to cause a respective controller of the subsequent vehicle to arrive at the incident scene to update one or more of the third application and the fourth application based on the input.

11. The system of claim 1, wherein the at least one controller is further configured to:
when the vehicle is the subsequent vehicle to arrive at the incident scene:
receive input for one or more of the third application and the fourth application; and
communicate, via the transceiver with the first vehicle to arrive at the incident scene to cause a respective controller of the first vehicle to arrive at the incident scene to update one or more of the first application and the second application based on the input.

12. A method comprising:
determining, at a computing device, via a transceiver, whether a vehicle is a first vehicle or a subsequent vehicle to arrive at an incident scene;
when the vehicle is the first vehicle to arrive at the incident scene:
selectively enabling, via the computing device: a first application for presentation at a vehicle display of the vehicle; and a second application for presentation at a mobile display of a mobile device, the vehicle and the mobile device communicatively coupled to each other; and
when the vehicle is the subsequent vehicle to arrive at the incident scene:
selectively enabling, via the computing device: a third application, different from the first application, for presentation at the vehicle display; and a fourth application for presentation at the mobile display.

13. The method of claim 12, wherein the transceiver comprises a vehicle-to-vehicle transceiver.

14. The method of claim 12, wherein:
the second application is a same as the fourth application; or
the second application is different from the fourth application.

15. The method of claim 12, further comprising determining whether the vehicle is the first vehicle or the subsequent vehicle to arrive at the incident scene by one or more of:
communicating, via the transceiver, with other vehicles at the incident scene; and
communicating, via the transceiver, with a cloud server configured to track vehicles at the incident scene.

16. The method of claim 12, further comprising:
controlling the mobile display to change based on interactions with the vehicle display; and
controlling the vehicle display to change based on respective interactions with the mobile display.

17. The method of claim 12, wherein the first application, the second application, the third application, and the fourth application are default applications determined at least partially on vehicle arrival order at incident scenes, and wherein the first application, the second application, the third application, and the fourth application are further modifiable or replaceable after the vehicle arrives at the incident scene.

18. The method of claim 12, further comprising:
when the vehicle is the subsequent vehicle to arrive at the incident scene:
selectively enabling the third application as a function of a determination of a respective first application currently enabled at a respective vehicle display of the first vehicle.

19. The method of claim 12, further comprising:
when the vehicle is the first vehicle to arrive at the incident scene:
receiving input for one or more of the first application and the second application; and
communicating, via the transceiver with the subsequent vehicle to arrive at the incident scene to cause a respective controller of the subsequent vehicle to arrive at the incident scene to update one or more of the third application and the fourth application based on the input.

20. The method of claim 12, further comprising:
when the vehicle is the subsequent vehicle to arrive at the incident scene:
receiving input for one or more of the third application and the fourth application; and
communicating, via the transceiver with the first vehicle to arrive at the incident scene to cause a respective controller of the first vehicle to arrive at the incident scene to update one or more of the first application and the second application based on the input.
